(19) United States
(12) Patent Application Publication
(10) Pub. No.: US 2014/0164447 A1
(43) Pub. Date: Jun. 12, 2014

(54) COOKIE SYNCHRONIZATION AND ACCELERATION OF THIRD-PARTY CONTENT IN A WEB PAGE

(71) Applicant: AKAMAI TECHNOLOGIES INC., Cambridge, MA (US)

(72) Inventors: Ashis Tarafdar, Wayland, MA (US); Guy Podjarny, Ottawa (CA)

(73) Assignee: AKAMAI TECHNOLOGIES INC., Cambridge, MA (US)

(21) Appl. No.: 13/748,136

(22) Filed: Jan. 23, 2013

Related U.S. Application Data
(60) Provisional application No. 61/736,166, filed on Dec. 12, 2012.

(51) Int. Cl. G06F 17/30

(52) U.S. Cl. CPC G06F 17/30194
USPC 707/827

(57) ABSTRACT

Described herein are, among other things, systems and methods for synchronizing cookies across different domains, and leveraging such systems and methods for content delivery. For example, two parties hosting content under different domain names from one another may desire to synchronize identification or ‘ID’ cookies that hold identifiers for a given client and/or end-user, so that one or both of the parties can map a given identifier from one domain to the identifier used in the other domain. Without limitation, some techniques described herein leverage one or more proxy servers that may be part of a distributed computing platform known as a content delivery network. Further, by way of example, some of the techniques for cookie synchronization can be leveraged to accelerate the delivery of content on a website with content from multiple domains.

This application is based on and claims the benefit of priority of U.S. Provisional Application No. 61/736,166, filed Dec. 12, 2012, the teachings of which are hereby incorporated by reference in their entirety.

### BACKGROUND

1. Technical Field

This disclosure generally relates to data processing apparatus and to client-server systems for delivering online content, among other things.

2. Brief Description of the Related Art

It is known the art, in accordance with the HTTP protocol, for a server identified by a given domain name to store one or more cookies on the client machine of an end-user visiting a website hosted by that server. The cookie contains typically data relevant to the client or to the end-user, such as state information for a given web session, a record of visits, purchases, and/or other past activities on the website by the end-user. Further, a cookie might contain a unique identifier for the client, allowing them to identified and tracked on subsequent visits (sometimes referred to as an ID cookie). Whatever information the cookie(s) might store, when the client returns to the website, it sends its cookies to the server and thereby enables the server to access the stored data.

According to convention, a server sets a cookie to be accessible only within the host domain (e.g., foo-A.com or shoppingcart.foo-A.com, etc.). The cookie's scope may also be limited to a particular path (e.g., /user) within the domain. Thus, the cookie's domain and path determine the scope of the cookie, and they tell the client that the cookie should only be sent back to a server hosting the stated domain and path, e.g., as part of the client's content request to that server. This generally means that cookies set in one domain are not accessible to hosts in another domain.

In some cases, however, there is a need to synchronize cookies across domains. For example, in the online advertising industry, bidders and ad exchanges often need to synchronize ID cookies so that in online auctions for advertising space managed by the ad exchange, the bidder can identify a particular client internally given the ad exchange's identifier. As another example, a website owner may need to synchronize cookies with an outside analytics service, so that the analytics service can identify a particular client internally given the website owner's identifier. Further a website owner may operate a multi-domain site, and need to synchronize cookies across those disparate domains. As a result, certain cookie synchronization techniques have been developed.

Current cookie synchronization techniques require a complicated series of messages between multiple parties. This is not only slow, due to the round trips involved, but also requires a high degree of coordination amongst the involved parties.

For example, it is known in the art to use a series of HTTP redirects (302 responses) to synchronize cookies between two machines. FIG. 1 illustrates such a process. Assume that Party A hosts ‘foo-A.com’ on Server A, Party B hosts ‘foo-B.com’ on Server B, and that the Parties desire to synchronize ID cookies.

The process begins when an end-user client 100 makes a HTTP ‘Get’ request to foo-A.com for an object. The object may be, for example, a match tag or pixel placed on a web page for the purpose of initiating the synchronization process. Server A is able to read the ID cookie from its domain (e.g., ID=123) and issue a HTTP 302 redirect to foo-B.com, placing its cookie in the redirect URL as a parameter, a technique sometimes referred to as ‘piggybacking’ the cookie. Server B receives the subsequent request for the redirect URL from the end-user client and reads the foo-A.com ID cookie, while also receiving its own foo-B.com ID cookie (e.g., ID=456) from the client, since the client will send its foo-B.com cookies as part of the request. Hence, Server B now has both ID cookies and can establish a mapping between the two. Server B can then deliver the pixel (the 1 xl image) to the client 100. Alternatively, as shown by the dotted arrows, Server B could issue another redirect to foo-A.com, placing its cookie in the redirect URL as a parameter. This way, Server A will receive the foo-B.com ID cookie and also can establish the mapping between the two ids.

As mentioned above, this and other prior art approaches for cookie synchronization are slow and complex.

There is a need to improve the speed and reduce the complexity of existing cookie synchronization techniques. Moreover, there is also a need to improve content delivery on websites that source content from multiple domains. As will be described below, improved cookie synchronization techniques can facilitate methods and systems for delivering web content sourced from multiple domains.

The teachings hereof address these needs and offer advantages and functionality which will become clear in view of this disclosure.

### BRIEF SUMMARY

This disclosure describes, among other things, improved systems and methods for synchronizing cookies across different domains, and for leveraging those systems for content delivery solutions, including solutions for sites that incorporate third-party content.

For example, two parties hosting content under different domain names from one another may desire to synchronize identification or ‘ID’ cookies that hold identifiers for a given client or end-user, so that one or both of the parties can map a given identifier from one domain to the identifier used in the other domain. Some of the techniques described herein leverage one or more proxy servers that may be part of a distributed computing platform known as a content delivery network. Furthermore, improved techniques for cookie synchronization can facilitate new ways of accelerating the delivery of content. In situations where a particular website is built on content from multiple domains (e.g., a web page from one domain with embedded content from another domain), the techniques in some embodiments enable cookies from the different domains to be mapped to one another, and this mapping can be used to apply content acceleration techniques. For example, an ID cookie for a given client received in a request for a web page in a first domain can be used to determine a corresponding ID cookie(s) for that client in second domain. This information can be used to prefetch embedded content from the second domain (among other acceleration techniques).

The foregoing merely refers to non-limiting embodiments of the subject matter disclosed herein. The appended claims define the scope of the invention and are also considered to be part of the disclosure hereof. The teachings hereof may be realized in a variety of systems, methods, apparatus, and non-transitory computer-readable media. It is also noted that the allocation of functions to different machines is not limiting, as the functions recited herein may be combined or split amongst different machines in a variety of ways.

### BRIEF DESCRIPTION OF THE DRAWINGS

The teachings hereof will be more fully understood from the following detailed description taken in conjunction with the accompanying drawings, in which:

FIG. 1 is a schematic diagram illustrating a known cookie synchronization technique;

FIG. 2 is a schematic diagram illustrating one embodiment of a known distributed computer system configured as a content delivery network;

FIG. 3 is a schematic diagram illustrating one embodiment of a machine on which a content delivery server in the system of FIG. 1 can be implemented;

FIG. 4 is a schematic diagram illustrating one embodiment of a cookie synchronization technique according to the teachings hereof;

FIG. 5 is a schematic diagram illustrating one embodiment of a cookie synchronization technique according to the teachings hereof;

FIG. 6 is a schematic diagram illustrating one embodiment of a cookie synchronization technique according to the teachings hereof;

FIG. 7 is a schematic diagram illustrating one embodiment of a cookie synchronization technique according to the teachings hereof;

FIG. 8 is a flowchart illustrating one embodiment of logic flow operative at a proxy server;

FIG. 9 is a flowchart illustrating one embodiment of logic flow operative at a proxy server; and,

FIG. 10 is a block diagram illustrating hardware in a computer system that can be used to implement the teachings hereof.

### DETAILED DESCRIPTION

The following description sets forth embodiments of the invention to provide an overall understanding of the principles of the structure, function, manufacture, and use of the methods and apparatus disclosed herein. The systems, methods and apparatus described herein and illustrated in the accompanying drawings are non-limiting examples; the scope of the invention is defined solely by the claims. The features described or illustrated in connection with one exemplary embodiment may be combined with the features of other embodiments. Such modifications and variations are intended to be included within the scope of the present invention. All patents, publications and references cited herein are expressly incorporated herein by reference in their entirety.

Some embodiments described herein make use of an intermediary between a client and a server. For example, some embodiments make use of an edge-deployed proxy server, as utilized in a distributed computing platform configured as a content delivery network. Hence for illustrative purposes an example of a content delivery network is described below.

As used herein, a domain name, or sometimes simply a ‘domain,’ is used to refer to a name that designates a realm of administrative authority on the Internet. An example of a domain name is “example.com”, which indicates a particular top level domain (“.com”) and a second level domain (“example”). Such a domain name may have subdomains, such as “images.example.com” and “www.example.com”, which are also themselves domain names. If in use, a domain name typically is resolved through the domain name system (DNS system) to identify a particular network host or device, e.g., a particular machine or set of machines.

In this disclosure, the term ‘URL’ is used to refer to a ‘uniform resource locator’. As those skilled in the art will recognize, according to convention a given URL may contain several components or fields, including a protocol (also referred to as a scheme), a hostname, a path (which may include a filename, if the URL is pointing to a particular file/resource rather than a directory), a query (e.g., a query string with query parameters), and a fragment. Thus a representative URL may be written as <protocol>://<hostname>/<path><query><fragment>. However, a URL need not contain all of these components.

CDN

One kind of distributed computer system is a “content delivery network” or “CDN” that is operated and managed by a service provider. The service provider typically provides the content delivery service on behalf of third parties. A “distributed system” of this type typically refers to a collection of autonomous computers linked by a network or networks, together with the software, systems, protocols and techniques designed to facilitate various services, such as content delivery or the support of outsourced site infrastructure. Typically, “content delivery” refers to the storage, caching, or transmission of content—such as web pages, streaming media and applications—on behalf of content providers, and ancillary technologies used therewith including, without limitation, DNS query handling, provisioning, data monitoring and reporting, content targeting, personalization, and business intelligence.

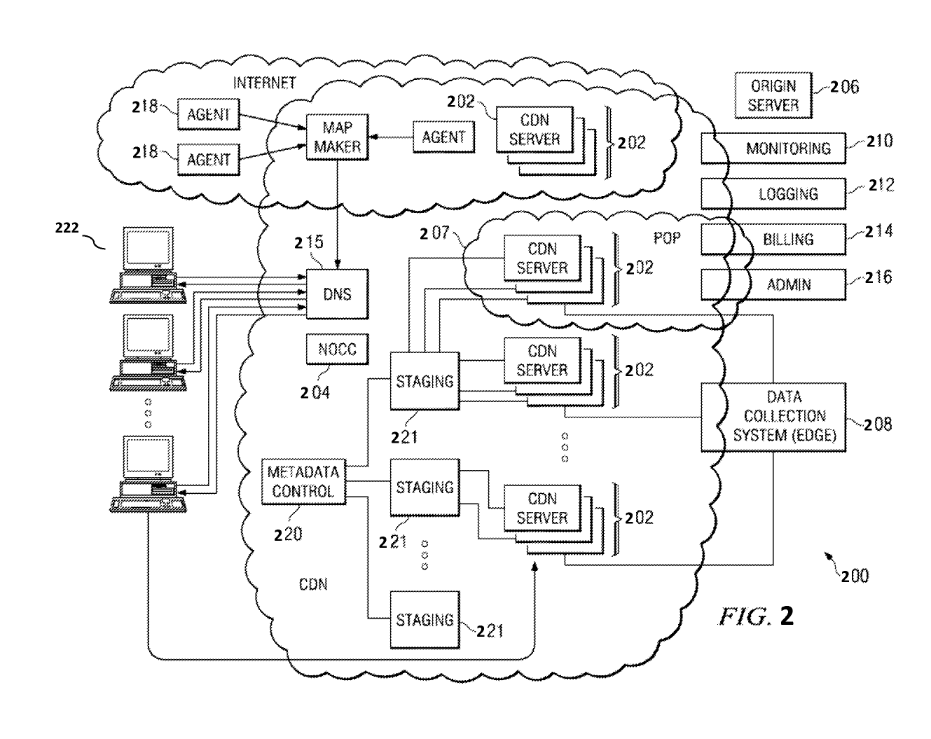

In a known system such as that shown in FIG. 2, a distributed computer system 200 is configured as a content delivery network (CDN) and is assumed to have a set of machines 202a-n distributed around the Internet. Typically, most of the machines are configured as servers and located near the edge of the Internet, i.e., at or adjacent end user access networks. A network operations command center (NOCC) 204 may be used to administer and manage operations of the various machines in the system. Third party sites affiliated with content providers, such as web site 206, offload delivery of content (e.g., HTML, embedded page objects, streaming media, software downloads, and the like) to the distributed computer system 200 and, in particular, to the servers (which are sometimes referred to as “edge” servers in light of the possibility that they are near an “edge” of the Internet). Such servers may be grouped together into a point of presence (POP) 207.

Typically, content providers offload their content delivery by aliasing (e.g., by a DNS CNAME or otherwise) given content provider domains to domains that are managed by the service provider's authoritative domain name service. End user client machines 222 that desire such content may be directed to the distributed computer system to obtain that content more reliably and efficiently. The CDN servers respond to the client requests, for example by obtaining requested content from a local cache, from another CDN server, from the origin server 206, or other source.

Although not shown in detail in FIG. 2, the distributed computer system may also include other infrastructure, such as a distributed data collection system 208 that collects usage and other data from the CDN servers, aggregates that data across a region or set of regions, and passes that data to other back-end systems 210, 212, 214 and 216 to facilitate monitoring, logging, alerts, billing, management and other operational and administrative functions. Distributed network agents 218 monitor the network as well as the server loads and provide network, traffic and load data to a DNS query handling mechanism 215, which is authoritative for content domains being managed by the CDN. A distributed data transport mechanism 220 may be used to distribute control information (e.g., metadata to manage content, to facilitate load balancing, and the like) to the CDN servers.

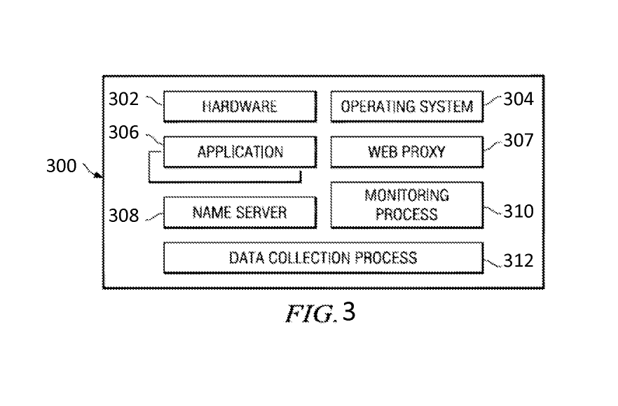

As illustrated in FIG. 3, a given machine 300 in the CDN (sometimes referred to as an “edge machine”) comprises commodity hardware (e.g., an Intel Pentium processor) 302 running an operating system kernel (such as Linux or variant) 304 that supports one or more applications 306a-n. To facilitate content delivery services, for example, given machines typically run a set of applications, such as an HTTP proxy 307, a name server 308, a local monitoring process 310, a distributed data collection process 312, and the like. The HTTP proxy 307 (sometimes referred to herein as a global host or “ghost”) typically includes a manager process for managing a cache and delivery of content from the machine. For streaming media, the machine typically includes one or more media servers, such as a Windows® Media Server (WMS) or Flash® server, as required by the supported media formats.

The machine shown in FIG. 3 may be configured to provide one or more extended content delivery features, preferably on a domain-specific, customer-specific basis, preferably using configuration files that are distributed to the content servers using a configuration system. A given configuration file preferably is XML-based and includes a set of content handling rules and directives that facilitate one or more advanced content handling features. The configuration file may be delivered to the CDN content server via the data transport mechanism. U.S. Pat. Nos. 7,240,100 and 7,111,057 illustrate a useful infrastructure for delivering and managing CDN server content control information and this and other content server control information (sometimes referred to as “metadata”) can be provisioned by the CDN service provider itself, or (via an extranet or the like) the content provider customer who manages the origin server.

The CDN may include a network storage subsystem (sometimes referred to herein as “NetStorage”) which may be located in a network datacenter accessible to the content servers, such as described in U.S. Pat. No. 7,472,178, the disclosure of which is incorporated herein by reference.

The CDN may operate a server cache hierarchy to provide intermediate caching of customer content; one such cache hierarchy subsystem is described in U.S. Pat. No. 7,376,716, the disclosure of which is incorporated herein by reference.

Proxy Server Cookie Matching

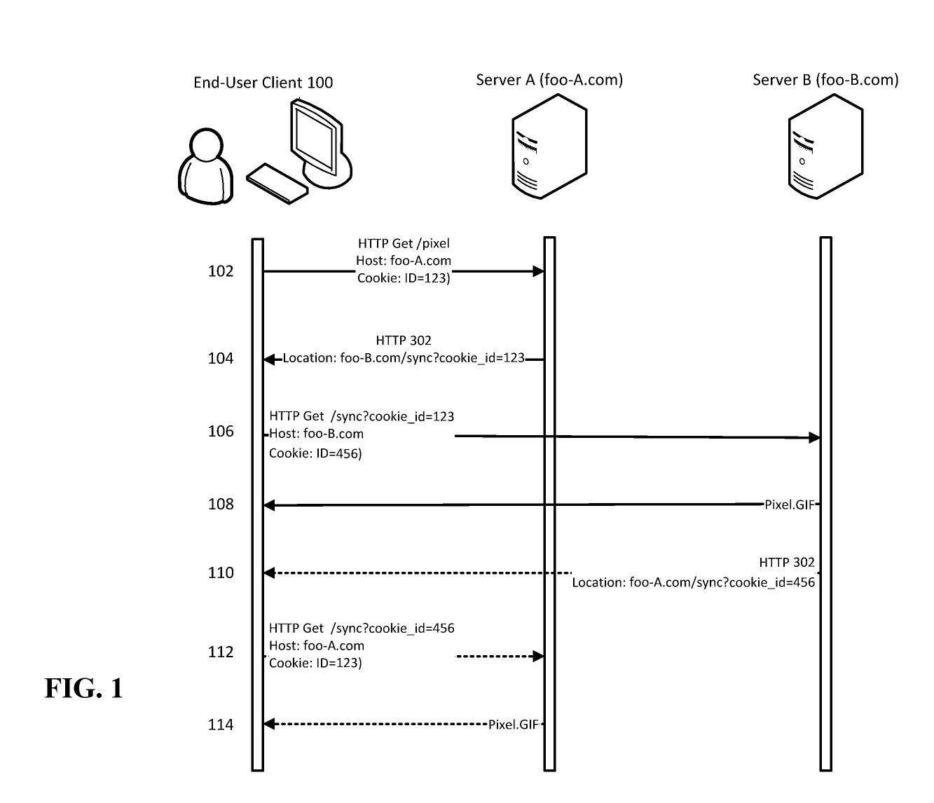

An enhancement to the redirect technique described with respect to FIG. 1 involves using a proxy server to facilitate the cookie-match, e.g., as a cookie-matching service provided to Party A and Party B. Preferably, the proxy server is located at a network edge, closer to the end-user client 100 than Servers A and B, in terms of network distance and latency. Preferably, the proxy server is part of a set of distributed server platform operated as a content delivery network (CDN), as described above, although this is not limiting.

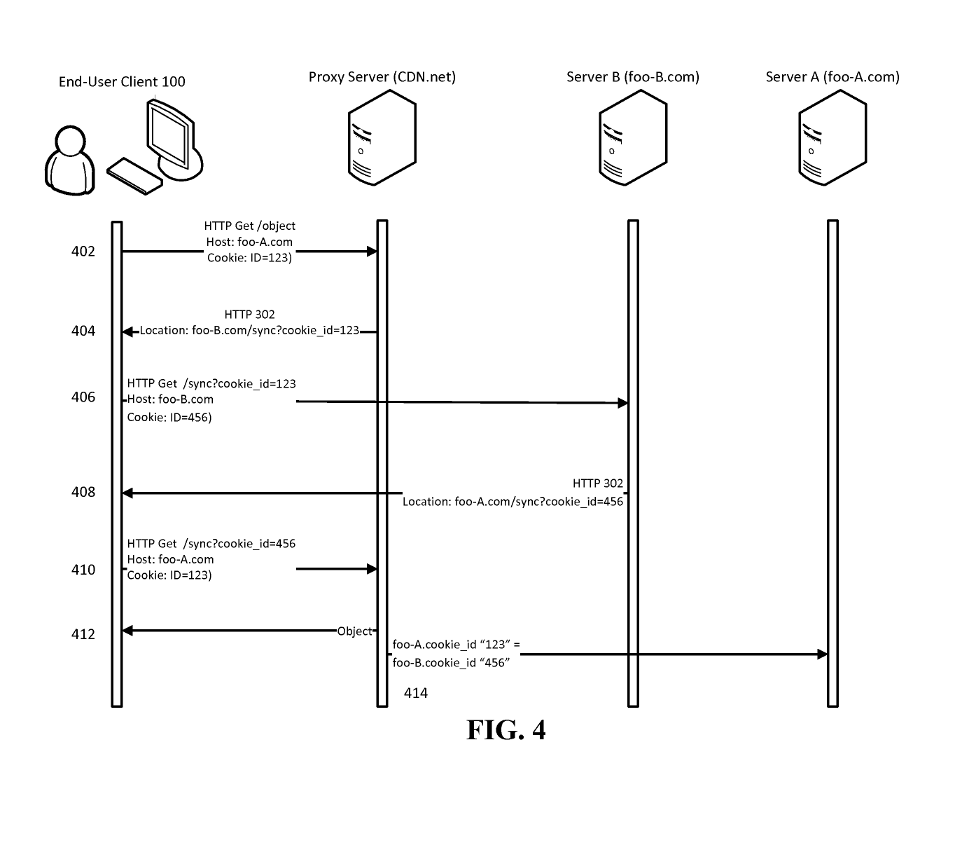

Referring now to FIG. 4, assume initially the end-user client 100 seeks to connect to a host identified by a given domain name, here the example is ‘foo-A.com.’ The end-user client machine's associated client DNS (not shown) looks up this domain to determine the machine address to connect with. Via a DNS entry alias (e.g., a CNAME, zone delegation, or otherwise), the client DNS is directed to and subsequently makes a DNS request to the proxy server domain (e.g., a CDN domain, which in the illustrated example is ‘CDN.net’) and receives back the machine address of the proxy server to return to the client. An example of this process is taught for example in U.S. Pat. No. 6,108,703, the teachings of which are hereby incorporated by reference. Any aliasing technique known in the art may be used.

At 402, the client 100 makes a request to the proxy server for content (e.g., for a pixel, other image, or other web page object). Upon receiving this request, the proxy server invokes a content handling configuration for foo-A.com to determine how to handle this request (e.g., as specified in configuration metadata as taught in U.S. Pat. No. 7,240,100 the teachings of which are hereby incorporated by reference). In this case, assume the configuration indicates that a request for this object should be handled as a cookie-syncing request and provides the necessary parameters to perform the cookie sync (e.g., which domain with which to perform the cookie sync, information necessary to decode the cookie, etc.). Note that in alternate embodiments, information relating to the cookie synchronization process may be placed in the request URL as a parameter, or even in the requested object (which the proxy server can periodically obtain from Server A and cache locally).

The proxy server contains logic to extract the ID cookie from the client's request and insert it into a redirect URL to foo-B.com, as shown in step 404, causing the client to make a request to Server B, as shown in step 406. If no reciprocal cookie sync is necessary, then in this example the proxy server's role is done and Server B would provide the requested content to the client. However, in the embodiment illustrated here, foo-B.com responds with its own redirect providing its ID cookie with “ID=456” in the URL (408). Following the DNS aliasing process, the redirect will arrive back at the proxy server (410), which then serves the requested object (412) and stores the association between the two ID cookies (e.g., foo-A.cookie_id of 123 equals foo-B.cookie_id of 456). At that point or some later time, the association is reported back to Party A, as shown in step 414.

The redirect technique illustrated in FIG. 1 involved several round-trips, so one advantage of using the proxy server to perform the cookie matching service is the reduction in round-trip time during certain legs of the process. More specifically, in the flow shown in FIG. 4, the proxy server's location close to the client means that the client 100's initial request to foo-A.com and the redirect back to foo-A.com have been accelerated.

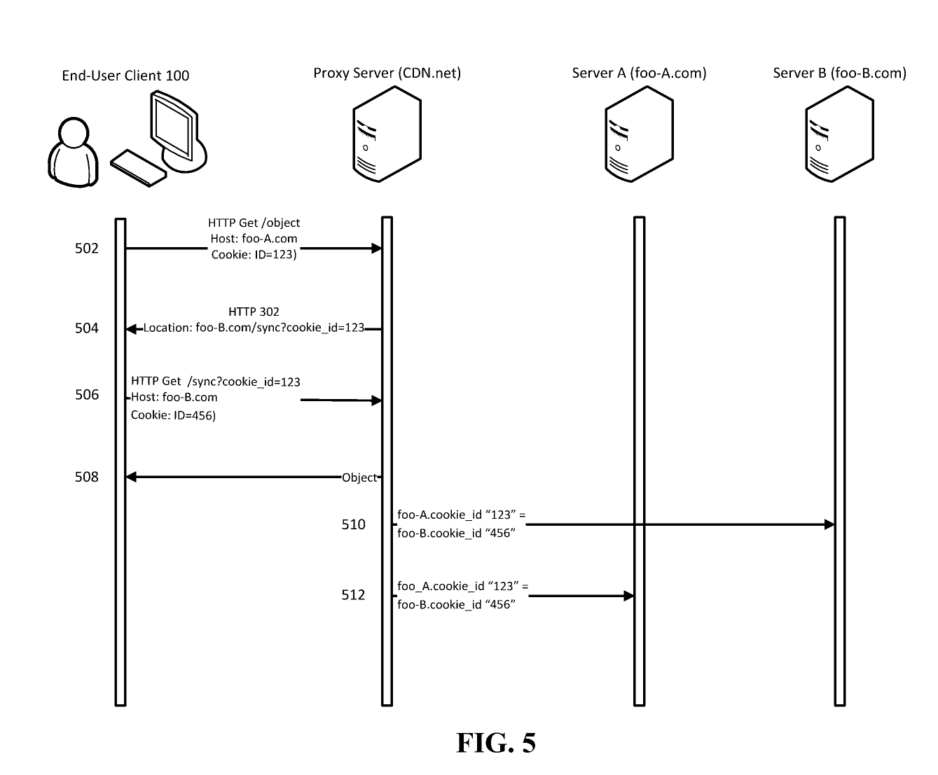

In an alternate embodiment, illustrated in FIG. 5, both Parties may funnel the cookie-sync process through the proxy server, rather than only Party A doing so. Thus, both foo-A.com and foo-B.com can be aliased to the proxy server. When the initial request for the object arrives under foo-A.com (at 502), the proxy server determines that foo-B.com is the domain with which synchronizing is desired (e.g., from the metadata configuration or otherwise). The proxy server issues a redirect to foo-B.com (504), which results in the client making a request to the proxy server and providing its cookies (including the ID cookie) for foo-B.com (506). The proxy server now has ID cookies for both domains, so it does not need to redirect back to the foo-A.com domain. Rather, it can send the requested content to the client (508), create an association/mapping between the two ID cookies, and send that mapping to Party A and/or Party B (510, 512).

Note that if the association between the ID cookies is cached at the proxy server or a remote storage accessible to the proxy server, it is possible to accelerate the process further: when the proxy server receives the initial request (502) from the client and receives foo-A.com's cookies, it can perform an internal lookup in a cookie association cache, using the foo-A.com ID cookie as a key, to see if it already has an associated foo-B.com ID cookie. If so, then the proxy server does not need to redirect to foo-B.com and wait for a response (as in step 504 and 506), but instead can serve the requested content and report the mapping between the cookies (508).

The above technique can be used to synchronize across cookie-isolated subdomains, as can any of the other embodiments described herein.

Proxy Server ‘Silent’ Cookie Syncing

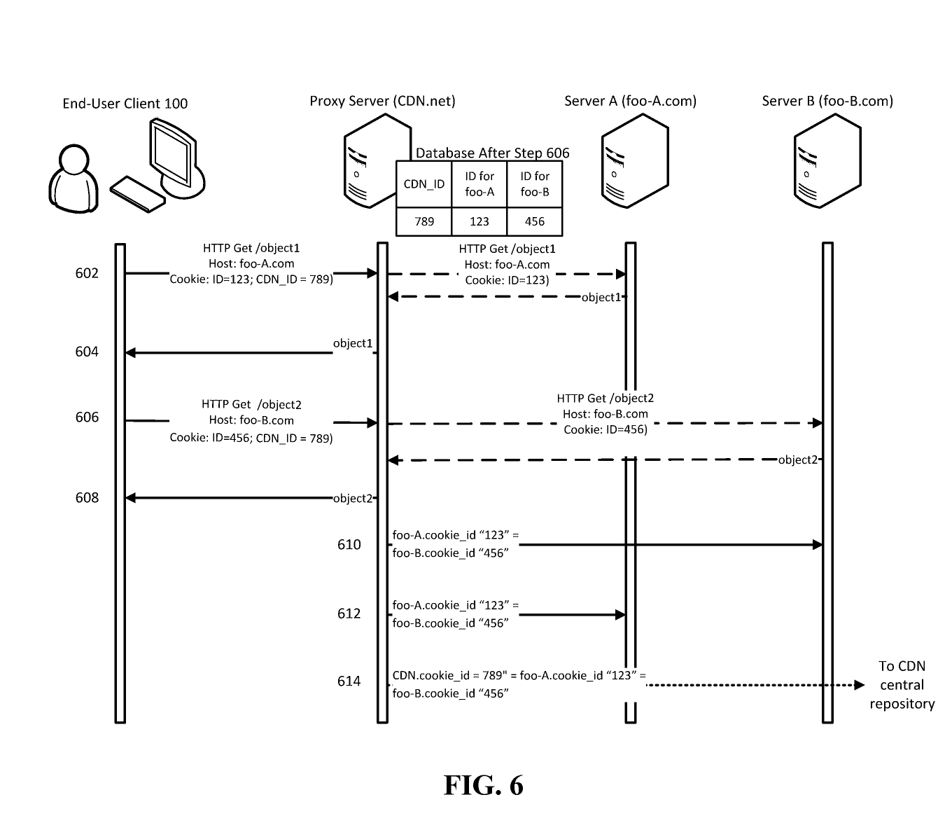

In another embodiment, a proxy server performs so-called ‘silent’ cookie syncing, in that the proxy server does not issue redirect responses as described above. Instead, the proxy server records and correlates ID cookies that are exposed during requests for content that the proxy server is handling. FIG. 6 illustrates this embodiment. Assume that Parties A and B are content providers who have arranged for traffic to their domains to be handled by the CDN, as described above. Accordingly, a given client 100 may make a request to the proxy server for content available at foo-A.com (step 602). As part of a HTTP ‘Get’ request, the client 100 sends to the proxy server the cookie(s) it has for foo-A.com. One of these cookies is the ID cookie for foo-A.com, and the proxy server records this cookie in a local database 606. In some embodiments, the proxy server may also read an ID cookie which was set under foo-A.com by the CDN itself (referred to hereinafter the CDN ID cookie or CDN ID), as described in U.S. Pat. No. 8,255,489, the teachings of which are hereby incorporated by reference. The proxy server stores the CDN ID cookie in the database as well, as shown in FIG. 6.

To fulfill to the client's request for the object, the proxy server may retrieve the object from a local cache, if the object is stored and valid (e.g., not expired) for delivery, or may make a forward request (shown with a dotted line) to Server A to obtain the object, and then relay it to the client 100 (604).

At a subsequent time, assume that the same client 100 makes a request to the proxy server for an object in the foo-B.com domain (606). The foregoing process repeats, with the proxy server obtaining the foo-B.com ID cookie and the CDN ID cookie, storing them in the database, and servicing the client's request for the object.

As a result of this process, the proxy server can establish a mapping between ID cookies across domains and report those mappings to CDN customers Party A and Party B. In this implementation, the mapping is keyed by the CDN ID cookie in the database. At steps 610 and 612, the proxy server can report the pairing to Parties A and B.

It should be noted that in practice, a given client 100 may not be guaranteed to return to the same proxy server in a given set of proxy servers. Thus, the database is preferably maintained across proxy servers in the CDN—potentially across servers in a particular region or across some other subset of proxy servers in the CDN—or even across the entire CDN platform. A given proxy server can report an ID cookie mapping, once determined, to a central repository (shown in FIG. 6 as an optional step 614), which can then report the pairings to participating CDN content providers or take other action.

Cookie Syncing Via Proxy Server URL Modification

In another embodiment, a proxy server synchronizes cookies by rewriting URLs on-the-fly. This technique to the situation, among others, where Party A is a content provider with a website at foo-A.com and Party A has arranged for another party, Party B, to provide certain content on the site from Party B's own domain. Party B in this case might be a social media network, analytics or web monitoring vendor, advertiser, a party that provides site enhancements with embedded news/content feeds (using web API calls, for example), or otherwise. For purposes of illustration, assume Party A has published an html document (or other markup language document using XML or WML, or other content) on its site with an embedded URL(s) pointing to foo-B.com for such content. The content from Party B is typically referred to as “third-party content” on Party A's site, which is typically referred to as the “first-party” site.

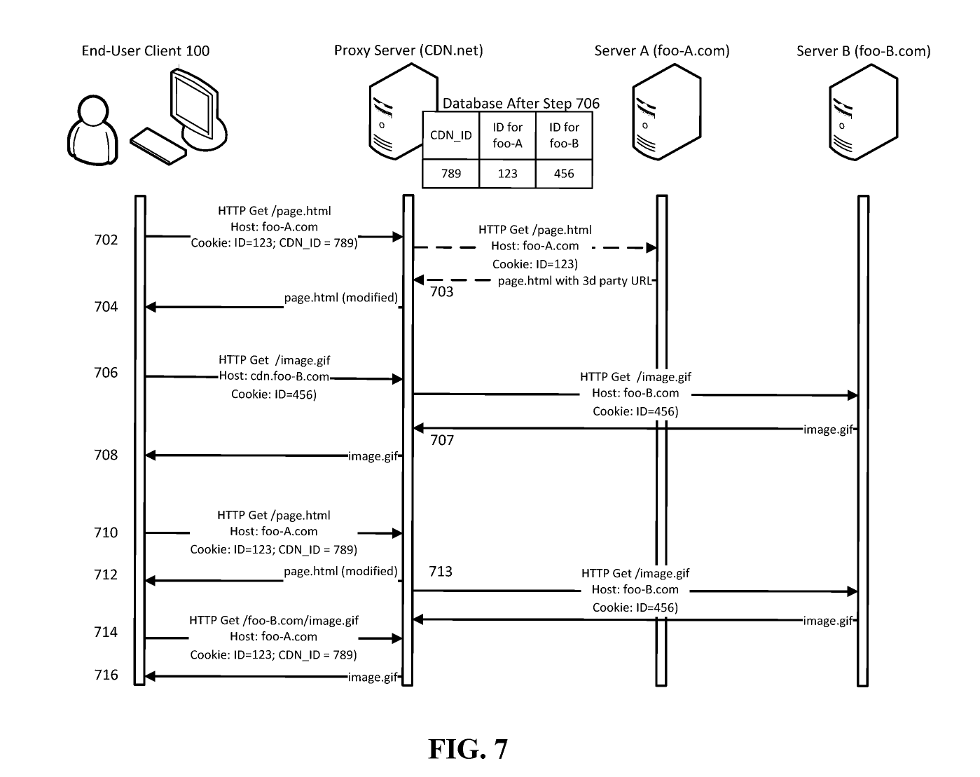

FIG. 7 illustrates, in a non-limiting embodiment, the cookie-syncing process in the above situation. As before, an end-user client 100 seeks content at foo-A.com, and as a result of a DNS lookup to foo-A.com which is aliased to the CDN domain, the client 100 is given the machine address of the proxy server to handle content requests for foo-A.com. In step 702, the client 100 makes a request for a given html file to the proxy server, and sends the cookies for foo-A.com with this request. (If the proxy server is part of a CDN and the CDN previously set a CDN ID cookie under the content provider's domain, as described in U.S. Pat. No. 8,255,489, then this CDN ID cookie is sent as well (e.g., CDN_ID=789), although this is optional.) The proxy server obtains the requested html file from local cache or by making a forward request to Server A, as shown with dotted lines in FIG. 7. Either way, assume the html file contains a URL for an embedded image that points to a domain other than the content provider domain; for example:

<img src=“http://foo-B.com/image.gif” height=“50” width=“50”>

(The embedded object might be any type of content, be it images, or code, or videos, or other html, iframes, or otherwise, etc. The example of an image is used solely for illustrative purposes.)

The proxy server parses the html file and upon seeing this URL (in this case, within the image tag), the proxy server sees that the domain foo-B.com is outside of the foo-A.com domain. In some implementations, the proxy server may refer to a content handling routine that instructs the proxy server to look for the foo-B.com domain as a known 3d party provider for the foo-A website. In other implementations, the proxy server can examine the domain names in the URLs to determine that the URL pointing to foo-B.com represents embedded third-party content. (Note that the hostname in the URL that triggers this may be the ‘foo-B.com’ name alone, as shown above, or a name containing the ‘foo-B.com’ domain name, such as ‘www.foo-B.com.’) The proxy server determines whether cookies have been synchronized for foo-A.com and foo-B.com and whether there is an existing (e.g., cached) mapping between them. The first time that the process takes place, there will be no such mapping.

If there is no such mapping, in order to synchronize cookies, the proxy server modifies the URL to point to a domain for Party B that has been aliased to the CDN, preferably a subdomain of a Party B domain name. In this embodiment, the aliased domain is one under which Party B has placed its ID cookie 100 on the client, i.e., a domain that is within the valid scope of the cookie so that the cookie will be accessible for requests made to the aliased domain. In FIG. 7, the example is: cdn.foo-B.com. The html file with the modified URL is sent to the client 100 (704).

While the example above involves modifying the URL to point to an aliased subdomain of the Party B domain, it does not necessarily have to be a subdomain. For example, the Party B could also set up an alternate domain (e.g., foo-B-shadow.com) that is aliased to the CDN. Party B would need to arrange for the same ID cookies to be placed in both foo-B.com and foo-B-shadow.com. It could do this as follows: when a client visits foo-B.com, Party B sets its ID cookie and issues a redirect to foo-B-shadow.com with the cookie piggybacked in the URL, and foo-B-shadow.com then sets the same ID cookie under its domain. This requires extra configuration and time because of the redirect, but if the cookie ids do not change, it only has to be done the first time a client visits foo-B.com.

Returning to FIG. 7, the cdn.foo-B.com subdomain (or foo-B-shadow.com alternate domain) has been aliased to the CDN, e.g., by CNAMING or DNS zone delegation or otherwise. Thus, when the client DNS seeks to resolve this name, it points to the CDN domain (in this example, CDN.net) and ultimately resolves to a CDN proxy server machine address, assume for the moment that it is the same proxy server as before. Hence, in step 706, client 100 makes a request for the embedded object, image.gif, to the proxy server. The client 100 will also send its cookies for Party B's domain, foo-B.com, with this request (or, in the alternate approach, the cookies sent will be for the foo-B-shadow.com domain, which nevertheless are the same cookies as for foo-B.com). As a result, the proxy server now has the ID cookie for foo-A.com and the corresponding ID cookie for foo-B.com. A mapping between these ID cookies is established and stored for later use, and can be reported to Party A and Party B via a back-end communication channel as was explained in prior examples.

Note that to establish the cookie mapping the proxy server will typically need to know that the cookies received with the request at 702 are to be associated with the cookies received with the request at 706. These two requests may be separated in time and even may be received at different proxy servers in the CDN. The synchronization process is preferably handled asynchronously. Hence, it is preferable that when modifying the URL to point to the subdomain or shadow domain (at 703/704), the proxy server also inserts some information into the URL to keep state and signify that the URL is part of a cookie synchronization process. This information may include the foo-A.com cookie ID (e.g., piggybacking it into the URL), information about Party A or foo-A.com, a special character sequence indicating that the request is part of a cookie sync process, etc., such that at 706 this information can simply be read from the URL by the receiving proxy server and acted upon accordingly to complete the cookie mapping. In short, the proxy server preferably embeds state into the URL at 703/704 and/or inserts a pointer to stored state information on the proxy server.

Because a CDN typically contains multiple proxy servers, once the cookie mapping is established, the mappings are shared across the CDN or at least across a subset of proxy servers in the CDN, at least in some embodiments.

Moving to step 708, the proxy server responds to the client's request by obtaining image.gif from Server B and returning it to the client 100. To reduce integration complexity and as shown in FIG. 7, the proxy can modify the forward request to Server B to remove the CDN subdomain and insert the usual domain name, so that no changes are needed at Server B in terms of content locations in order to handle and service the request (707). Thus, beyond the configuration needed to effect the DNS alias, the integration required from Party B may be minimized.

Note that in some cases, in step 706 the client 100 may not have any cookies to send for Party B's domain, because it may be the first time that the client 100 has requested content from Party B's site, or because they have been deleted from the client machine 100, for example. In such a case, the response from the server of Party B (at 707) may include a directive to set an ID cookie on the client 100. The proxy server may, in some embodiments, capture this ID cookie, map it to the CDN ID cookie and/or Party A's ID cookie, and store it for later use, all before sending the set cookie directive onwards to the client 100 (at 708). In this way, cookie synchronization can be achieved the first time that the client 100 appears on the third-part (Party B) site, as the ID cookie is being set.

Acceleration of Third-Party Content

The synchronization of cookies in FIG. 7 provides an opportunity for the proxy server to accelerate the third party content from foo-B.com. By accelerating Party B's third-party content, though, the CDN can improve the load time of the page of Party A.

Turning again to FIG. 7, assume that at some time after the synchronization takes place, the same or another end-user client returns to the website and requests page.html from the proxy server (710). This time, the proxy server sees the embedded link to foo-B.com and realizes that the cookie mapping is already established. The proxy server rewrites the URL in the page so that it will be aliased to the CDN domain, typically by rewriting it to the first party content provider's domain, which in this example is foo-A.com. The proxy server can place a third-party identifier in the path of the URL, so that later on the proxy server can determine the third-party that the modified URL refers to. Thus for example the proxy may rewrite as follows:
http://foo-B.com/image.gif→http://foo-A.com/foo-B.com/image.gif

The proxy server sends the file with the modified URL to the client 100 (at 712). Since the CDN is handling aliased foo-A.com, the client's request for the embedded third-party object will come to the proxy server. In anticipation of this request for the third-party content, the proxy server can pre-fetch the embedded object from Server B. The foo-B.com ID cookie must be used to make a complete and proper forward request to Server B for the content, which is potentially personalized content. Because of the previously-established cookie mapping, the proxy server has the foo-B.com ID cookie. Hence, the proxy server uses the foo-A.com ID cookie to determine the appropriate foo-B.com ID cookie, based on the previously established mapping, and pre-fetches the object (713). When the client 100 eventually parses the modified page.html and issues the request for image.gif (714), the proxy server has already obtained the object and can send it to the client immediately.

Note that in step 714 the client's request is for http://foo-A.com/foo-B.com/image.gif. The proxy server recognizes this as a special URL due to the embedded foo-B.com in the path, and recognizes that the object to deliver to the client is at http://foo-B.com/image.gif, which has been pre-fetched and stored in the cache at the proxy server. (Alternatively, a special sequence of characters could be inserted in the path to indicate to the proxy server in that the URL is a rewritten third-party URL, e.g., http://foo-A.com/special-prefix/foo-B.com/image.gif)

Note that the proxy server can modify the URL in a variety of ways and that the above is but one example. For example, in an alternate embodiment, the URL in the page can be modified as follows:
http://foo-B.com/image.gif→http://foo-B.com.foo-A.com/image.gif

This is then sent (at 712) and the subsequently (at 714) the proxy server is configured to recognize this as the special URL and act accordingly.

Beyond pre-fetching, another advantage of the foregoing technique is that the URL for the modified page.html itself and the embedded object URL are now at the same domain, i.e., the host is foo-A.com (see the client requests at 710 and 714, in which the hostnames are the same). This domain consolidation allows a suitably capable client browser to operate more efficiently in terms of multiplexing connections to the proxy server and other enhancements. Both examples of rewritten URLs illustrate this domain consolidation technique.

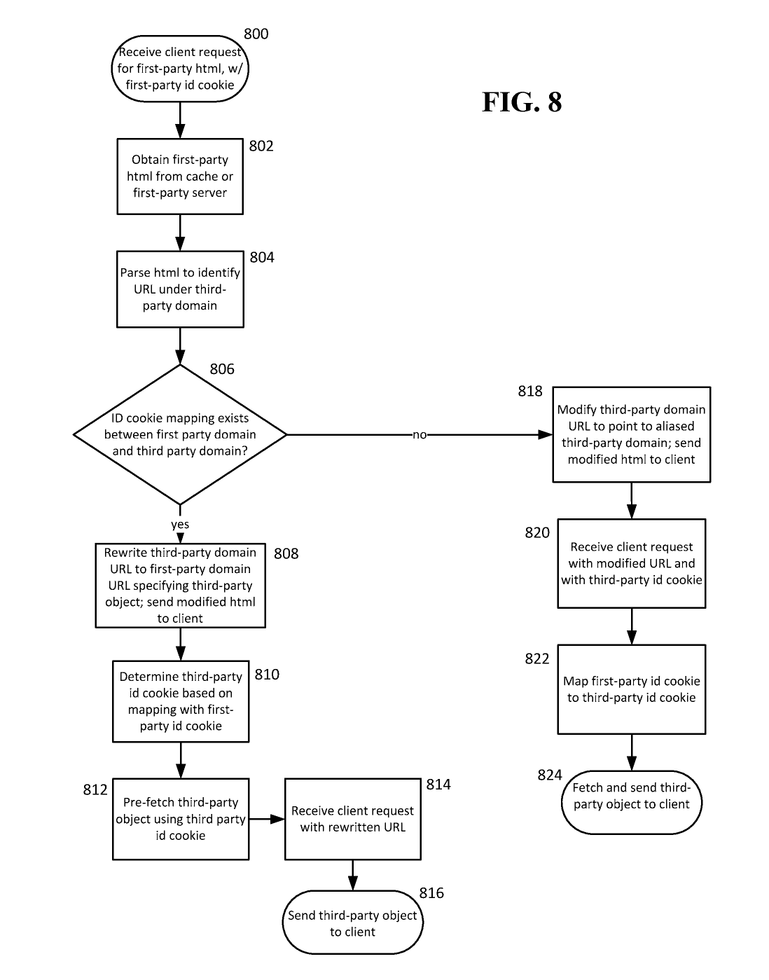

FIG. 8 is a flowchart illustrating a non-limiting example of the operation of the proxy server focusing on the conditional modification of a third-party URL and acceleration of third-party content discussed above in connection with FIG. 7.

In step 800, the proxy server receives a client request for first-party html (or other content with embedded URLs), and client also sends its cookies for the first-party domain. In step 802, the proxy server obtains an html document, e.g., from cache or from the first-party server. The proxy server parses the html to find the URL pointing to an embedded third party object hosted under a third-party domain, see step 804. In step 806, if the proxy server already has a mapping between the first-party and third-party domains, it branches to 808. If not, it branches to 818 in order to establish that mapping. In step 818, the proxy server modifies the third-party domain URL to point to a third party domain aliased so as to be handled by the proxy server/CDN, preferably a subdomain. The html with this modified URL is sent to the client. Subsequently the client makes a request for the third-party object at the modified URL and along with this request sends the third-party ID cookie (step 820). In step 822 the proxy server maps the first-party ID cookie to the third-party ID cookie and stores this association. The proxy server then fetches and sends the third-party object to the client, in step 824.

In the branch beginning with step 808, the proxy server modifies the URL to point to the first-party domain for domain consolidation purposes (and also specifies the location of the third-party object in the URL path) and serves the html file with this modified URL to the client. In anticipation of receiving a request for this URL back from the client, the proxy server looks up the third-party ID cookie based on the first-party ID cookie and pre-fetches the third-party object using this information (810, 812). When the client request is subsequently received (814), the proxy server can serve the third-party object without the delay of fetching the object (816).

It should be understood that the while the examples above involve modification of URLs in a markup language page that point to an embedded object, this is not a limitation. In some cases, a page returned from Server A in step 703 may contain or reference code (e.g., Javascript or other script) that sources third-party content on Server B, e.g., by causing the client to construct a URL with a third-party domain like foo-B.com and issue a request for content at such URL. In this scenario, the proxy server can modify the code as it passes through the proxy server such that it no longer calls the third-party domain for content but rather points to the domain aliased to the CDN (e.g., cdn.foo-B.com or the alternate domain, as described above). This modified code can be returned in step 704 for execution by the client 100. (Steps 712 of FIGS. 7 and 808 and 818 of FIG. 8 would accordingly also involve the modification of code to create the appropriate URL.)

Third Party is a Participating Content Provider

The approaches described in connection with FIGS. 7-8 generally involved a third party, Party B, that was not using the CDN already to deliver content. Alternatively, if Party B were using the CDN to deliver content (e.g., as a participating customer/content provider), then the original foo-B.com domain would not need to be modified at step 704 of FIG. 7. That foo-B.com domain would already be aliased to the CDN. Thus, in this embodiment, the proxy server would recognize that the foo-B.com domain is being handled by the CDN (in other words, Party B is a participating content provider). As a result at 704 the proxy server would not modify the foo-B.com domain name (and/or would not modify the code generating the URL with that domain name, if the URL were being generated by such code), and return the page to the client 100. Note that the proxy server might nevertheless modify the URL by embedding state or inserting a pointer to state in the URL, as previously described, so that the subsequent request for the URL can be identified as part of a cookie synchronization context/flow.

Continuing this example, at 706, the client would make a request using the foo-B.com domain, which would be aliased to the CDN and handled by the proxy server (either the same proxy server or another in the CDN). The proxy server could capture the ID cookie for foo-B.com at that point, and be able to make the association between the ID cookies for foo-A.com and foo-B.com. The resulting synchronization of ID cookies could be used to accelerate delivery of the Party B's content embedded on Party A's page, using the prefetching and/or domain consolidation approaches described above with respect to FIG. 7 (at 710 through 716).

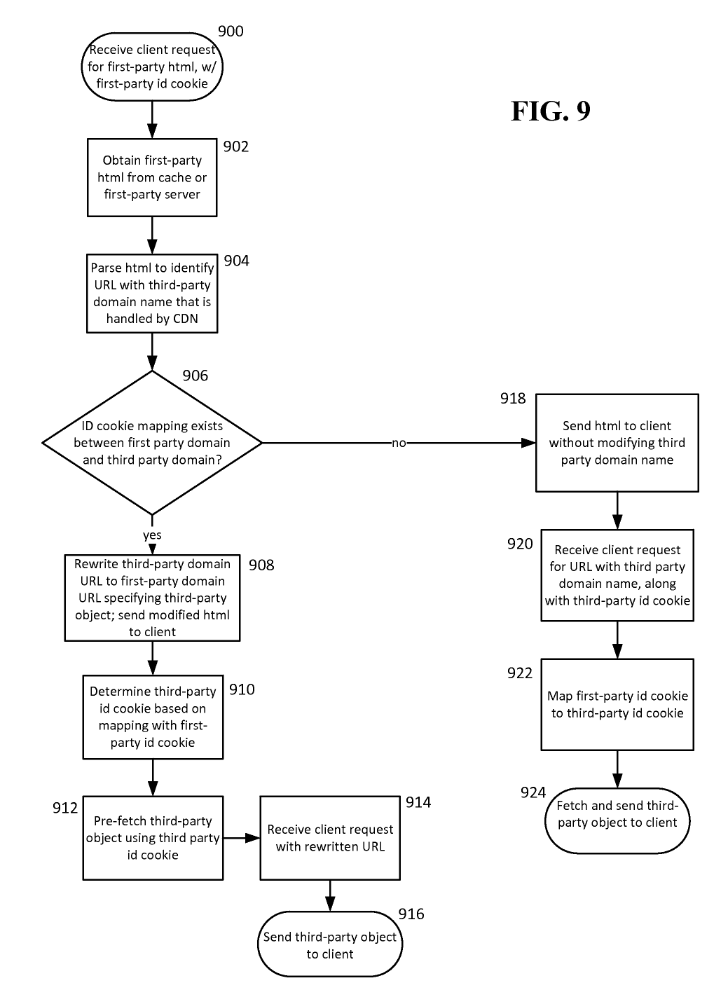

FIG. 9 is a flowchart illustrating a non-limiting example of the operation of the proxy server when Party B is a participating CDN content provider, as just described.

It should be noted that because the CDN is handling Party B's content delivery, another way for the proxy server to capture the foo-B.com ID cookie is to do so when the proxy server is receiving a request for content at the Party B website (that is, a user seeking to go directly to the Party B website in another flow; and not when seeking Party B's embedded content on the Party A site). Using the CDN ID as described earlier with respect to FIG. 6, the cookies could be synchronized through use of a cookie database storing cookie mappings. Again, the resulting synchronization of ID cookies could be used to accelerate delivery of the Party B's content embedded on Party A's page, using the approaches described above with respect to FIG. 7 (at 710 through 716).

Use of Computer Technologies

The clients, servers, and other devices described herein may be implemented with conventional computer systems, as modified by the teachings hereof, with the functional characteristics described above realized in special-purpose hardware, general-purpose hardware configured by software stored therein for special purposes, or a combination thereof.

Software may include one or several discrete programs. Any given function may comprise part of any given module, process, execution thread, or other such programming construct. Generalizing, each function described above may be implemented as computer code, namely, as a set of computer instructions, executable in one or more processors to provide a special purpose machine. The code may be executed using conventional apparatus—such as a processor in a computer, digital data processing device, or other computing apparatus—as modified by the teachings hereof In one embodiment, such software may be implemented in a programming language that runs in conjunction with a proxy on a standard Intel hardware platform running an operating system such as Linux. The functionality may be built into the proxy code, or it may be executed as an adjunct to that code.

While in some cases above a particular order of operations performed by certain embodiments is set forth, it should be understood that such order is exemplary and that they may be performed in a different order, combined, or the like. Moreover, some of the functions may be combined or shared in given instructions, program sequences, code portions, and the like. References in the specification to a given embodiment indicate that the embodiment described may include a particular feature, structure, or characteristic, but every embodiment may not necessarily include the particular feature, structure, or characteristic.

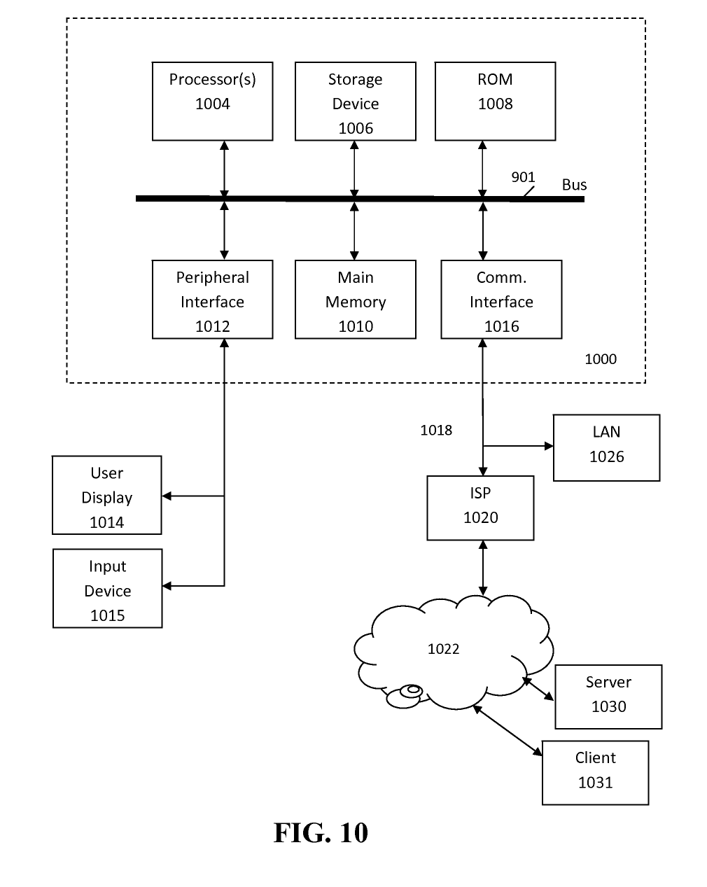

FIG. 10 is a block diagram that illustrates hardware in a computer system 1000 upon which such software may run in order to implement embodiments of the invention. The computer system 1000 may be embodied in a client device, server, personal computer, workstation, tablet computer, wireless device, mobile device, network device, router, hub, gateway, or other device. Representative machines on which the subject matter herein is provided may be Intel Pentium-based computers running a Linux or Linux-variant operating system and one or more applications to carry out the described functionality.

Computer system 1000 includes a processor 1004 coupled to bus 1001. In some systems, multiple processor and/or processor cores may be employed. Computer system 1000 further includes a main memory 1010, such as a random access memory (RAM) or other storage device, coupled to the bus 1001 for storing information and instructions to be executed by processor 1004. A read only memory (ROM) 1008 is coupled to the bus 1001 for storing information and instructions for processor 1004. A non-volatile storage device 1006, such as a magnetic disk, solid state memory (e.g., flash memory), or optical disk, is provided and coupled to bus 1001 for storing information and instructions. Other application-specific integrated circuits (ASICs), field programmable gate arrays (FPGAs) or circuitry may be included in the computer system 1000 to perform functions described herein.

Although the computer system 1000 is often managed remotely via a communication interface 1016, for local administration purposes the system 1000 may have a peripheral interface 1012 communicatively couples computer system 1000 to a user display 1014 that displays the output of software executing on the computer system, and an input device 1015 (e.g., a keyboard, mouse, trackpad, touchscreen) that communicates user input and instructions to the computer system 1000. The peripheral interface 1012 may include interface circuitry, control and/or level-shifting logic for local buses such as RS-485, Universal Serial Bus (USB), IEEE 1394, or other communication links.

Computer system 1000 is coupled to a communication interface 1016 that provides a link (e.g., at a physical layer, data link layer, or otherwise) between the system bus 1001 and an external communication link. The communication interface 1016 provides a network link 1018. The communication interface 1016 may represent a Ethernet or other network interface card (NIC), a wireless interface, modem, an optical interface, or other kind of input/output interface.

Network link 1018 provides data communication through one or more networks to other devices. Such devices include other computer systems that are part of a local area network (LAN) 1026. Furthermore, the network link 1018 provides a link, via an internet service provider (ISP) 1020, to the Internet 1022. In turn, the Internet 1022 may provide a link to other computing systems such as a remote server 1030 and/or a remote client 1031. Network link 1018 and such networks may transmit data using packet-switched, circuit-switched, or other data-transmission approaches.

In operation, the computer system 1000 may implement the functionality described herein as a result of the processor executing code. Such code may be read from or stored on a non-transitory computer-readable medium, such as memory 1010, ROM 1008, or storage device 1006. Other forms of non-transitory computer-readable media include disks, tapes, magnetic media, CD-ROMs, optical media, RAM, PROM, EPROM, and EEPROM. Any other non-transitory computer-readable medium may be employed. Executing code may also be read from network link 1018 (e.g., following storage in an interface buffer, local memory, or other circuitry).

Any trademarks appearing herein are for identification and descriptive purposes only. The enumeration and labeling of steps or elements in the Figures and corresponding descriptive text is for reference purposes only and is not intended to be limiting in any way.

We claim:

1. A system, comprising:
a first server associated with a first content provider and associated with a first domain name, the first server hosting a markup language file;
a second server associated with a second content provider and associated with a second domain name, the second server hosting an object referenced by a universal resource locator (URL) in the markup language file, the URL having a hostname component that contains the second domain name;
at least one proxy server that comprises circuitry forming one or more processors and memory holding computer-readable instructions that when executed by the one or more processors will cause the proxy server to:
receive from a client a request for the markup language file, and at least one cookie valid for the first domain;
request and receive the markup language file from the first server;
parse the markup language file to find the URL referencing the object;
determine that there is no stored association between the at least one first domain cookie and at least one cookie valid for the second domain;
upon the determination that the stored association does not exist, (a) modify the URL by replacing the second domain name in the URL's hostname component with a third domain name that is aliased to a fourth domain name associated with the at least one proxy server, and (b) send the markup language file with the modified URL to the client.

2. The system of claim 1, wherein the third domain name is a subdomain of the second domain name.

3. The system of claim 1, wherein the scope of the at least one cookie valid for the second domain includes the second domain and the third domain name.

4. The system of claim 1, wherein the instructions when executed by the one or more processors will cause the at least one proxy server to:
receive a subsequent request for the markup language file from the client or another client, and determine that there is a stored association between the at least one first domain cookie and the at least one cookie valid for the second domain, and upon said determination, use the stored association to identify the at least one second domain cookie.

5. The system of claim 4, wherein the instructions when executed by the one or more processors will cause the at least one proxy server to:
upon the determination that the stored association exists, request the object from the second server using the at least one second domain cookie, in anticipation of receiving a request from the client or said another client for the object.

6. The system of claim 4, wherein the instructions when executed by the one or more processors will cause the at least one proxy server to:
upon the determination that the stored association exists, (i) modify the URL by replacing the second domain name in the URL's hostname component with the first domain name, and (ii) send the markup language file with the modified URL from (i) to the client or said another client, in response to the subsequent request.

7. The system of claim 1, wherein the at least one first domain cookie and the at least one second domain cookie each include an identifier for the client or for an end-user.

8. The system of claim 1, wherein the instructions when executed by the one or more processors will cause the at least one proxy server to:
receive a request from the client for the object using the modified URL,
receive from the client at least one cookie valid for the second domain name, and
associate the at least one first domain cookie with the at least one second domain cookie.

9. A method performed by at least one computer, the method comprising:
receiving at least one cookie valid for a first domain name in a request from a client for content;
receiving a markup language file from a server associated with the first domain name;
examining the markup language file to find an embedded reference to an object, the reference pointing to a second domain name;
determining that there is no stored association between the at least one first domain cookie and at least one cookie valid for the second domain name;
upon the determination that the stored association does not exist, (a) modifying the reference to point to a third domain name that is aliased to a fourth domain name associated with the at least one computer, and (b) sending the markup language file with the modified reference to the client.

10. The method of claim 9, wherein the third domain name is a subdomain of the second domain name.

11. The method of claim 9, wherein the scope of the at least one cookie valid for the second domain includes the second domain and the third domain name.

12. The method of claim 9, further comprising:
receiving a subsequent request for the markup language file from the client or another client, and determine that there is a stored association between the at least one first domain cookie and the at least one cookie valid for the second domain, and upon said determination, use the stored association to identify the at least one second domain cookie.

13. The method of claim 12, further comprising:
upon the determination that the stored association exists, requesting the object from a second server using the at least one second domain cookie, in anticipation of receiving a request from the client or said another client for the object.

14. The method of claim 12, further comprising:
upon the determination that the stored association exists, (i) modifying the reference to point to the first domain name, and (ii) sending the markup language file with the modified reference from (i) to the client or said another client, in response to the subsequent request.

15. The method of claim 9 wherein the stored association is an association between an identifier in the at least one first domain cookie and an identifier in the at least one second domain cookie.

16. The method of claim 9, further comprising:
receiving a request from a client for the object using the modified reference;
receiving from the client at least one cookie valid for the second domain name;
associating the at least one first domain cookie with the at least one second domain cookie.

17. The method of claim 9, wherein the reference is a URL.

17-46. (canceled)
